(19) United States
(12) Patent Application Publication
(10) Pub. No.: US 2025/0119013 A1
(43) Pub. Date: Apr. 10, 2025

(54) ELECTRIC MOTOR WITH LIGHTWEIGHT MAGNETIC ROTOR

(71) Applicant: Joby Aero, Inc., Santa Cruz, CA (US)

(72) Inventors: Dylan Aramburu, Santa Cruz, CA (US); Jeffrey Cortes, Santa Cruz, CA (US); Wilson Hsu, San Carlos, CA (US); Yueqian Jia, San Carlos, CA (US)

(21) Appl. No.: 18/906,878

(22) Filed: Oct. 4, 2024

Related U.S. Application Data
(60) Provisional application No. 63/588,112, filed on Oct. 5, 2023.

(51) Int. Cl. H02K 1/2791; B64D 27/31

(52) U.S. Cl. CPC H02K 1/2791; B64D 27/31

(57) ABSTRACT

An electric motor comprises a rotor and a stator. The rotor includes a housing having an inner surface and an outer surface, a first end, and a second end. Permanent magnets are located along the inner surface of the rotor housing. At least one groove is defined in the first end of the rotor housing. A sealing member includes at least one protrusion located in the at least one groove. A honeycomb panel may be located in a recess defined in the outer surface of the rotor housing. The electric motor may form part of a propulsions system for an aircraft, used to drive a rotor assembly including rotor blades.

### RELATED APPLICATION DATA

This application claims the benefit of U.S. Application Ser. No. 63/588,112 filed Oct. 5, 2023, the contents of which are incorporated herein by reference as if explicitly set forth.

### TECHNICAL FIELD

This invention relates generally to electric motors for transportation, and more specifically in some examples to a new and useful electric aircraft motor for use in the aviation field.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1A to 1C are schematic partial cross sections of radial flux permanent magnet motor topologies, according to some examples.

FIG. 2 is a partial cross section through a perspective view of a rotor, according to some examples.

FIG. 3 is a partial sectional view of the rotor of FIG. 5, according to some examples.

FIG. 4 is a partial cross-section through a perspective view of a labyrinthine seal for use with the rotor of FIG. 2.

FIG. 5 is partial cross section through a perspective view of a rotor according to some examples.

FIG. 6 is a partial cross section through a perspective view of a rotor, according to some examples.

FIG. 7 is a perspective view of a honeycomb panel suitable for use in forming the ring surrounding the rotor housing of FIG. 5, according to some examples.

FIG. 8 is a partial sectional view of the rotor of FIG. 5, according to some examples.

FIG. 9 is a partial perspective view of the tubular portion and second flange of the lightweight rotor of FIG. 5, according to some examples.

FIG. 10 is a rear perspective view of a propulsion system for use in an aircraft, according to some examples.

FIG. 11 is a front perspective view of an aircraft, according to some examples.

### DETAILED DESCRIPTION

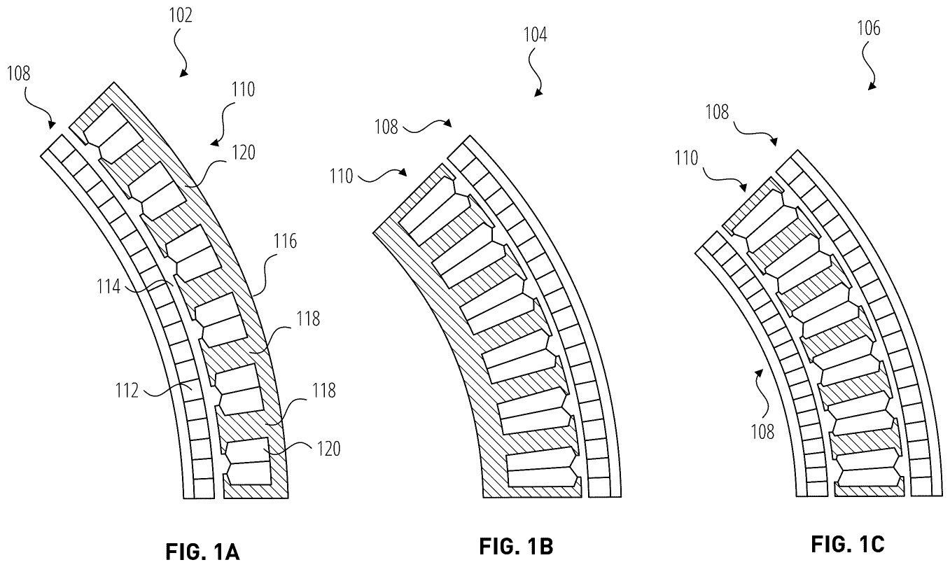

FIGS. 1A to 1C are schematic partial cross sections of radial flux permanent magnet motor topologies, according to some examples.

FIG. 1A illustrates an in-runner topology 102, in which a rotor 108 is located inside a stator 110. The rotor 108 includes a housing 112 and several permanent magnets 114 attached to the housing. The stator 110 includes a yoke 116 having several teeth 118, around which field coils 120 are wound. In use, magnetic fields generated by current passing through the field coils 120 act on the permanent magnets 504 to turn the rotor 108.

FIG. 1B illustrates an out-runner topology 104, in which the rotor 108 is located outside of, and rotates around, the stator 110.

FIG. 1C illustrates a dual-runner topology 106, in which two rotors 108, one inside the stator 110 and one outside the stator 110 are provided.

The concepts and structures described herein with reference to an out-runner topology 104, but it will be appreciated that these are equally applicable to other topologies such as in those described above.

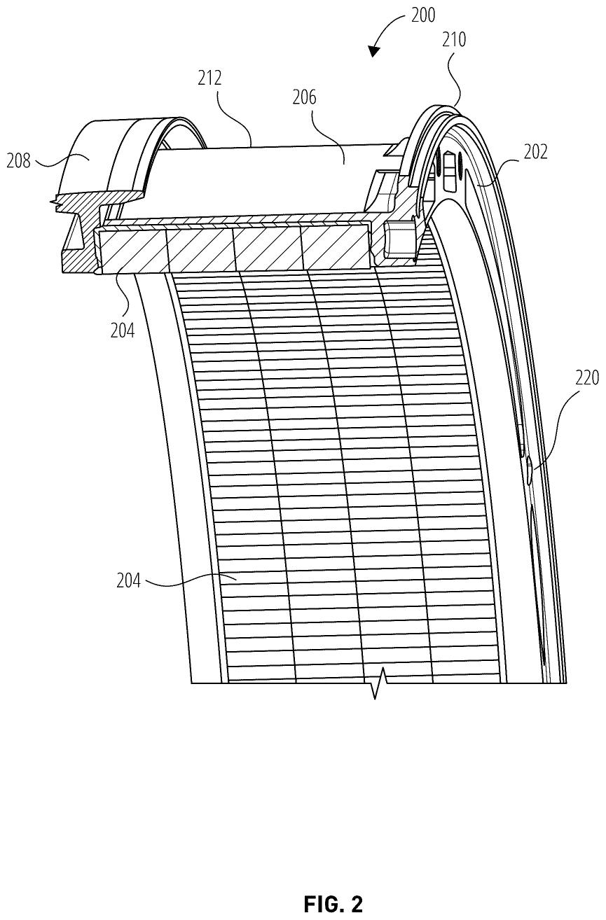

FIG. 2 is partial cross section through a perspective view of a lightweight rotor 200 according to some examples. The rotor 200 includes a rotor housing 202 and a plurality of permanent magnets 204.

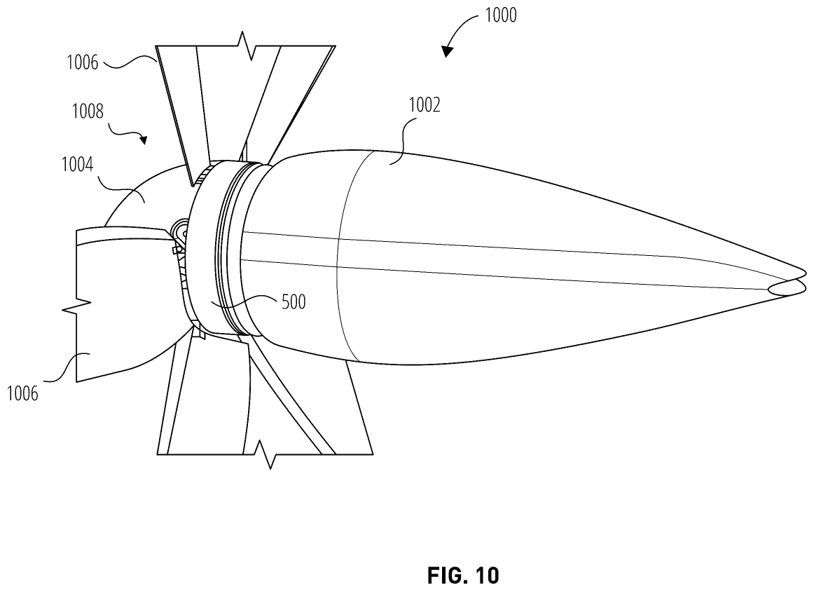

The rotor 200 is rotationally coupled to the stator (not shown) via a bearing (not shown). The rotor 200 is also coupled to a driven component such as a shaft or propeller hub via spaced-apart attachment points 220, while the stator may be coupled via a housing to a supporting structure such as an airframe, nacelle structure, or a tilt mechanism. The positioning of the rotor 200 in an aircraft 1100 is shown in FIG. 10.

The rotor 200 includes a rotor housing 202 and an array of permanent magnets 204 located in a circumferential recess defined by an inner surface of the rotor housing 202. The array of permanent magnets 204 is bonded in place in the rotor housing 202 using a film adhesive.

The rotor housing 202 comprises a first flange 208 and a second flange 210 joined by a tubular portion 212. A smooth outer surface 206, which is exposed to the air in some examples as shown in FIG. 10, is provided to reduce drag during rotation.

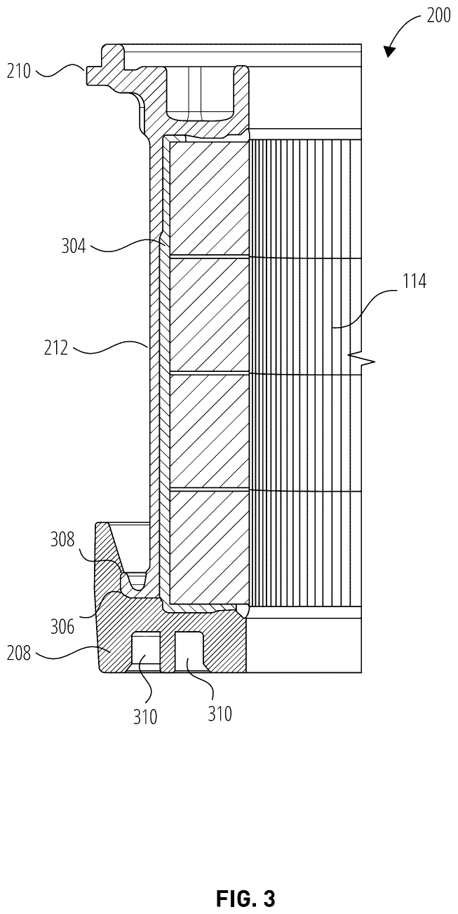

FIG. 3 is a partial sectional view of the rotor 200 of FIG. 2, according to some examples. As shown in the figure, in some examples the rotor housing 502 is formed in two parts, with the tubular portion 212 and the second flange 210 being formed as one part, with the first second flange 210 being formed as a separate part in the shape of a contoured ring. The first flange 208 is attached to the tubular portion 516 by means of an interference fit 306 between the tubular portion 212 and the first flange 208, provided in some cases by heating the first flange 208 prior to assembly and then allowing it to shrink onto the tubular portion 212 as it cools. The first flange 208 is also provided with a notch 308 into which a corresponding edge of the tubular portion 212 fits, for alignment purposes.

Also shown in FIG. 3 is the adhesive 304 by means of which the permanent magnets 204 are attached to the rotor housings 202.

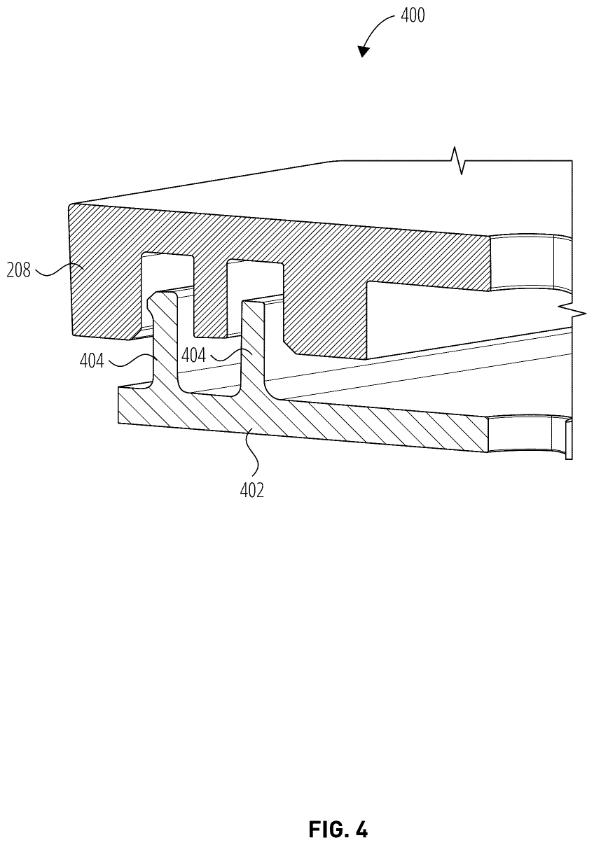

Grooves 310 are formed in an annular surface of the first flange 208. The grooves 310 form part of a labyrinthine seal 400, illustrated conceptually in FIG. 4.

FIG. 4 is a partial cross-section through a perspective view of a labyrinthine seal 400 for use with the rotor 200 of FIG. 2. The labyrinthine seal 400 is formed by the combination of the grooves 310 defined in the first flange 208 of the rotor 200 and a sealing ring 402 that includes one or more projections 404 that extend into the corresponding one or more grooves 310 in the first flange 208. The sealing ring 402 is coupled to the stator and is thus fixed relative to the nacelle 1002 (see FIG. 10), while the rotor 200 is coupled to and rotates with the rotor blades 1006 and the spinner 1004.

As can be seen, there is no contact between the sealing ring 402 and the first flange 208, so that the labyrinthine seal 400 does not impart contact frictional losses between the sealing ring 402 and the first flange 208 in use. However, it is more difficult for dust and debris to reach the interior of the rotor 200 as a result of the convoluted path defined between the grooves 310 of the first flange 208 and the projections 404 of the sealing ring 402.

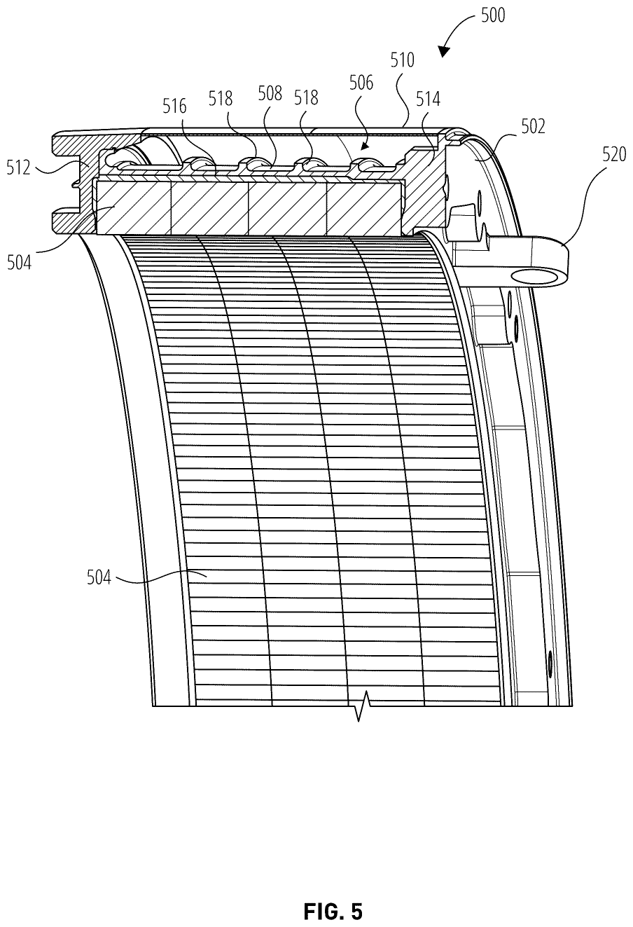

FIG. 5 is partial cross section through a perspective view of a lightweight rotor 500 according to some examples. The rotor 500 includes a rotor housing 502 and a plurality of permanent magnets 504.

The rotor 500 is rotationally coupled to the stator (not shown) via a bearing (not shown). The rotor 500 is also coupled to a driven component such as a shaft or propeller hub via spaced apart attachment points 520, while the stator is coupled via a housing to supporting structure such as an airframe, nacelle structure or a tilt mechanism.

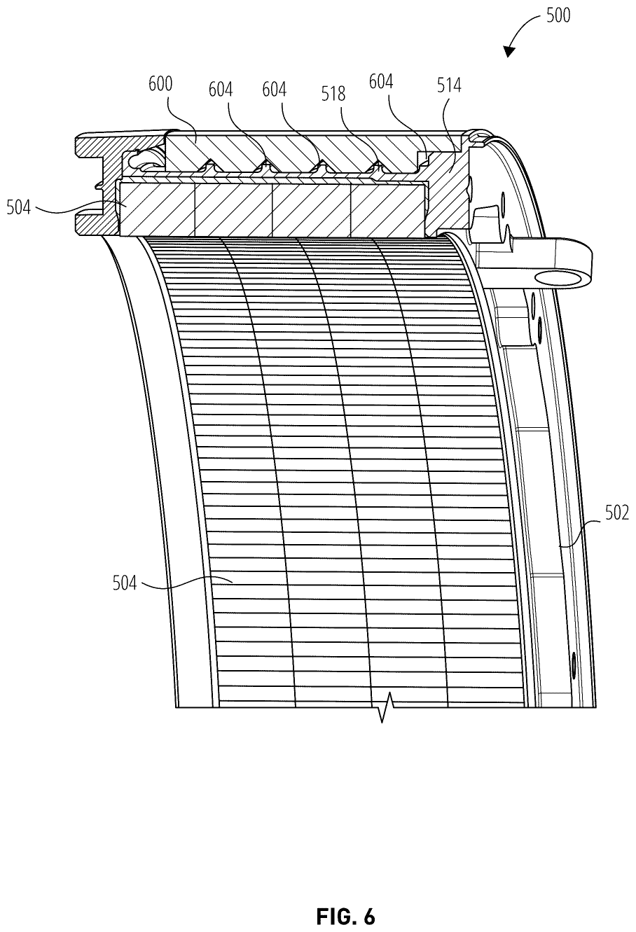

In some examples, the rotor 500 includes a rotor housing 502, an array of permanent magnets 504 located in a circumferential recess defined by an inner surface of the rotor housing 502, an aluminum honeycomb ring 600 (see FIG. 6) in a circumferential recess 506 defined by an outer surface 508 of the rotor housing 502, and an aluminum foil cover 510 covering the ring 600 and part of the outer surface 508 of the rotor housing 502.

The array of permanent magnets 504 is bonded in place in the rotor housing 502 using a film adhesive.

The rotor housing 502 comprises a first flange 512 and a second flange 514 joined by a tubular portion 516. A number of circumferential ribs 518 are provided on the outer surface 508 of the tubular portion 516 to provide additional stiffness to the rotor housing 502.

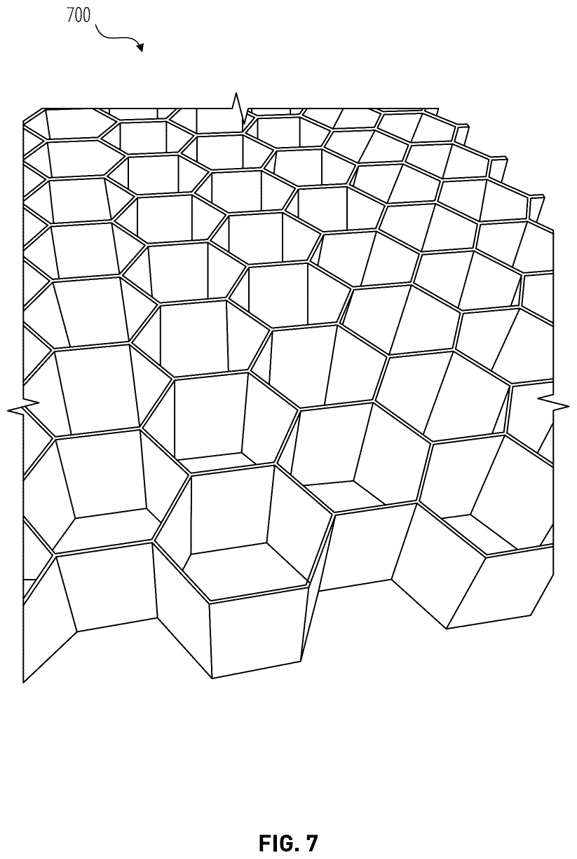

FIG. 6 is a partial cross section through a perspective view of the lightweight rotor 500 of FIG. 5, according to some examples. In this figure, the cover 510 has been removed to illustrate the placement and shape of the ring 600. The ring 600 is formed of a honeycomb panel 700 as discussed below with reference FIG. 7, and has cutouts 604 to accommodate the ribs 518 and other features of the profile of the rotor housing 502, for example at the second flange 514.

Conventional rotor housings are often made as solid metal tubes. To reduce mass, the rotor housing 502 is made of titanium. Titanium is a poor conductor of heat, however. The recess 506 is formed in the rotor housing 502 to reduce mass further, and the aluminum honeycomb ring 600 is provided to facilitate heat transfer from the rotor housing 502 to the cover 510 and from there away from the rotor housing 502.

FIG. 7 is a perspective view of a honeycomb panel 700 suitable for use in forming the ring 600 of the rotor 500 of FIG. 5, according to some examples. As can be seen, the walls of the honeycomb panel 700 are tangential to the plane of the panel itself. The honeycomb panel 700 thus provides compressive strength in a direction tangential to the panel but is flexible and can be bent around an axis parallel to the plane of the panel 700. An appropriately-sized honeycomb panel 700 with cut-outs as described above with reference to FIG. 6, can thus be wrapped around the tubular portion 516 of the rotor housing 502 and into the recess 506. The ends of the honeycomb panel 700 are then joined to form the ring 600, and in some examples the honeycomb panel 700 is also bonded to the outer surface 508. The hexagonal tubes forming the honeycomb panel 700 thus face in a radial direction when the ring 600 is assembled around the rotor housing 502.

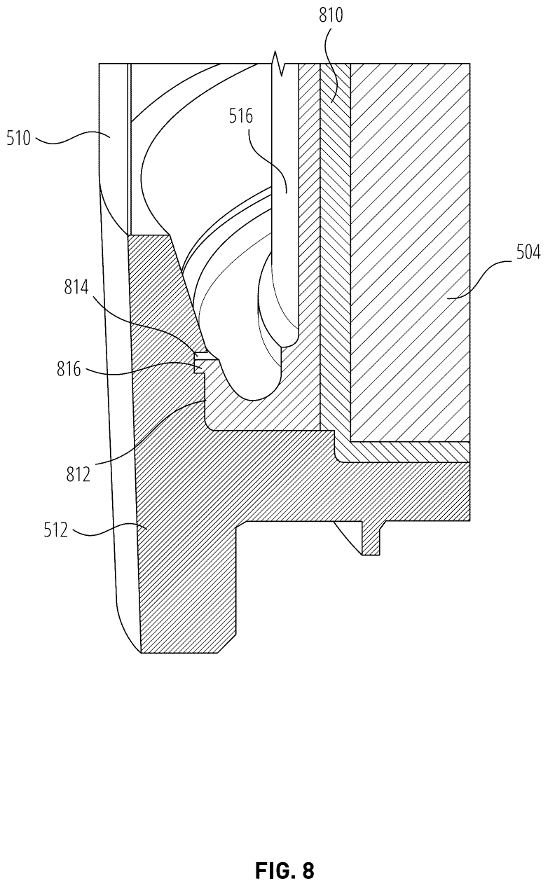

FIG. 8 is a partial sectional view of the rotor 500 of FIG. 5, according to some examples. As shown in the figure, in some examples the rotor housing 502 is formed in two parts, with the tubular portion 516 and the second flange 514 being formed as one part, with the first flange 512 being formed as a separate part in the shape of a contoured ring. The first flange 512 is attached to the tubular portion 516 by means of an interference fit 812, provided in some cases by heating the first flange 512 prior to assembly and then allowing it to shrink onto the tubular portion 516 as it cools. The first flange 512 is also provided with a notch 814 into which a corresponding tab 816 on the tubular portion 516 fits, for alignment purposes.

Also shown in FIG. 7 is the adhesive by means of which the permanent magnets 504 are attached to the rotor housings 502.

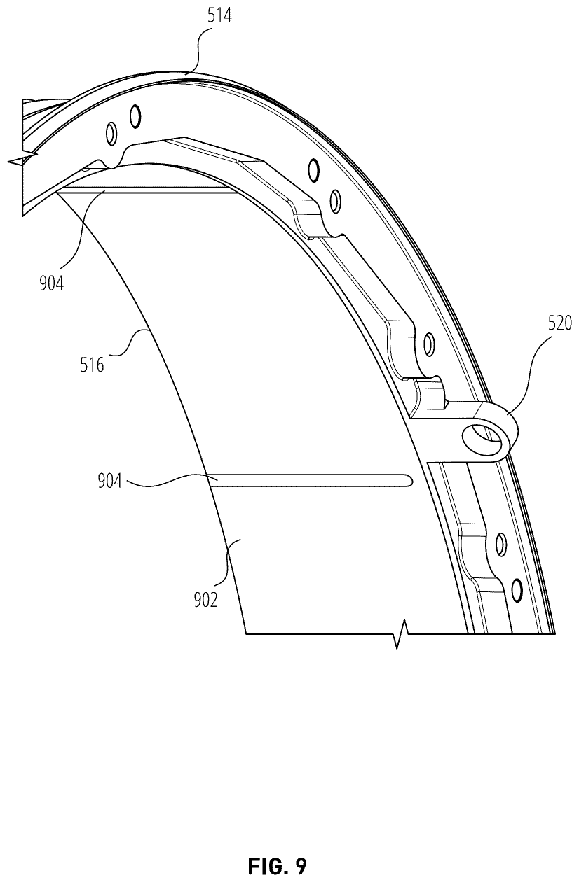

FIG. 9 is a partial perspective view of the tubular portion 516 and second flange 514 of the lightweight rotor 500 of FIG. 5, according to some examples. The array of permanent magnets 504 has been removed in FIG. 9, to illustrate the inner surface 902 of the tubular portion 516. A number of axial grooves 904 are defined in the inner surface 902 at regular intervals. The axial grooves 904 receive some of the adhesive 810 used to attach the permanent magnets 504 to the rotor housing 502, providing an additional mechanical link between the permanent magnets 504 and the tubular portion 516.

FIG. 10 is a rear perspective view of a propulsion system 1000 for use in an aircraft 1100, according to some examples. The propulsion system 1000 includes a nacelle 1002, which provides aerodynamic cover for support structure for a motor-driven rotor-blade rotor blade assembly 1008. The rotor blade assembly 1008 includes the rotor 200 or the rotor 500. The rotor 200/500 is coupled to rotor blades 1006 and a spinner 1004. Hidden from view underneath the rotor 200/500 is a stator that is coupled to the nacelle 1002. In use, current passing through the stator generates electromagnetic forces that operate on the permanent magnets 204/504 and thus on the rotor 200/500, which rotates the rotor blade assembly 1008 to provide thrust to the aircraft 1100.

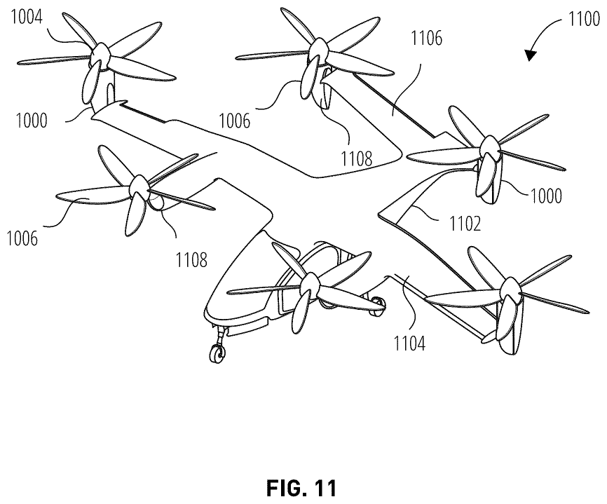

FIG. 11 is a front perspective view of an aircraft 1100, according to some examples. The aircraft 1100 includes a fuselage 1102, a wing 1104, a stabilizer 1106, a number of tiltable propulsion systems 1000, and a number of fixed propulsion systems 1108. The propulsion systems 1108 include a tilt mechanism that tilts an assembly including the rotor 500, stator, rotor blades 1006 and spinner 1004 between a horizontal and a vertical position. The propulsion systems 1108 and propulsion systems 1000 thus permit vertical takeoff and landing of the aircraft 1100, while also permitting vertical flight. The provision of lightweight rotors 500 as described herein aids heat transfer, and/or improved performance of the aircraft 1100 due to the decreased mass of the rotors 500 compared to traditional rotors.

Various examples are contemplated. Example 1 is an electric motor comprising a rotor and a stator, the rotor comprising: a rotor housing having an inner surface, an outer surface, a first end, and a second end; permanent magnets located along the inner surface of the rotor housing; at least one groove defined in the first end of the rotor housing; and a sealing member including at least one protrusion located in the at least one groove.

In Example 2, the subject matter of Example 1 includes, wherein the first end or the second end of the rotor comprises a flange that is attached to a central portion of the rotor by means of an interference fit.

In Example 3, the subject matter of Examples 1-2 includes, wherein the rotor further comprises circumferential ribs located on the outer surface of the rotor.

In Example 4, the subject matter of Examples 1-3 includes, wherein the rotor housing is made of titanium.

In Example 5, the subject matter of Examples 1-4 includes, wherein the rotor further comprises axial grooves defined in the inner surface of the rotor.

In Example 6, the subject matter of Examples 1-5 includes, a honeycomb panel located in a recess defined in the outer surface of the rotor housing.

In Example 7, the subject matter of Example 6 includes, an aluminum sheet covering the honeycomb panel.

In Example 8, the subject matter of Examples 6-7 includes, wherein the rotor further comprises circumferential ribs located on the outer surface of the rotor.

In Example 9, the subject matter of Examples 6-8 includes, wherein the honeycomb panel is positioned in the recess with cells of the honeycomb panel facing in a radial direction.

In Example 10, the subject matter of Examples 6-9 includes, wherein the honeycomb panel is made of aluminum.

In Example 11, the subject matter of Examples 6-10 includes, wherein the rotor further comprises axial grooves defined in the inner surface of the rotor.

Example 12 is a propulsions system for an aircraft, comprising: a rotor assembly including rotor blades and a rotor; and a nacelle including a stator, wherein the rotor comprises: a rotor housing having an inner surface, an outer surface, a first end, and a second end; permanent magnets located along the inner surface of the rotor housing; and at least one groove defined in the first end of the rotor housing; and wherein the stator comprises: a sealing member including at least one protrusion located in the at least one groove.

In Example 13, the subject matter of Example 12 includes, wherein the first end or the second end of the rotor comprises a flange that is attached to a central portion of the rotor by means of an interference fit.

In Example 14, the subject matter of Examples 12-13 includes, wherein the rotor further comprises axial grooves defined in the inner surface of the rotor.

In Example 15, the subject matter of Examples 12-14 includes, wherein the rotor further comprises circumferential ribs located on the outer surface of the rotor.

In Example 16, the subject matter of Examples 12-15 includes, wherein the rotor further comprises a honeycomb panel located in a recess defined in the outer surface of the rotor housing.

In Example 17, the subject matter of Example 16 includes, wherein the honeycomb panel is positioned in the recess with cells of the honeycomb panel facing in a radial direction.

In Example 18, the subject matter of Examples 16-17 includes, wherein the rotor further comprises circumferential ribs located on the outer surface of the rotor.

In Example 19, the subject matter of Examples 16-18 includes, an aluminum sheet covering the honeycomb panel.

In Example 20, the subject matter of Examples 16-19 includes, wherein the honeycomb panel is made of aluminum.

Example 21 is at least one machine-readable medium including instructions that, when executed by processing circuitry, cause the processing circuitry to perform operations to implement of any of Examples 1-20.

Example 22 is an apparatus comprising means to implement any of Examples 1-20. Example 23 is a system to implement any of Examples 1-20. Example 24 is a method to implement of any of Examples 1-20.

What is claimed is:

1. An electric motor comprising a rotor and a stator, the rotor comprising:
a rotor housing having an inner surface, an outer surface, a first end, and a second end;
permanent magnets located along the inner surface of the rotor housing;
at least one groove defined in the first end of the rotor housing; and
a sealing member including at least one protrusion located in the at least one groove.

2. The electric motor of claim 1, wherein at least one of the first end or the second end of the rotor comprises a flange that is attached to a central portion of the rotor by means of an interference fit.

3. The electric motor of claim 1, wherein the rotor further comprises circumferential ribs located on the outer surface of the rotor.

4. The electric motor of claim 1, wherein the rotor housing is made of titanium.

5. The electric motor of claim 1, wherein the rotor further comprises axial grooves defined in the inner surface of the rotor.

6. The electric motor of claim 1, further comprising a honeycomb panel located in a recess defined in the outer surface of the rotor housing.

7. The electric motor of claim 6, further comprising an aluminum sheet covering the honeycomb panel.

8. The electric motor of claim 6, wherein the rotor further comprises circumferential ribs located on the outer surface of the rotor.

9. The electric motor of claim 6, wherein the honeycomb panel is positioned in the recess with cells of the honeycomb panel facing in a radial direction.

10. The electric motor of claim 6, wherein the honeycomb panel is made of aluminum.

11. The electric motor of claim 6, wherein the rotor further comprises axial grooves defined in the inner surface of the rotor.

12. A propulsions system for an aircraft, comprising:
a rotor assembly including rotor blades and a rotor; and
a nacelle including a stator,
wherein the rotor comprises:
a rotor housing having an inner surface, an outer surface, a first end, and a second end;
permanent magnets located along the inner surface of the rotor housing; and
at least one groove defined in the first end of the rotor housing;
and wherein the stator comprises:
a sealing member including at least one protrusion located in the at least one groove.

13. The propulsions system of claim 12, wherein at least one of the first end or the second end of the rotor comprises a flange that is attached to a central portion of the rotor by means of an interference fit.

14. The propulsions system of claim 12, wherein the rotor further comprises axial grooves defined in the inner surface of the rotor.

15. The propulsions system of claim 12, wherein the rotor further comprises circumferential ribs located on the outer surface of the rotor.

16. The propulsions system of claim 12, wherein the rotor further comprises a honeycomb panel located in a recess defined in the outer surface of the rotor housing.

17. The propulsions system of claim 16, wherein the honeycomb panel is positioned in the recess with cells of the honeycomb panel facing in a radial direction.

18. The propulsions system of claim 16, wherein the rotor further comprises circumferential ribs located on the outer surface of the rotor.

19. The propulsions system of claim 16, further comprising an aluminum sheet covering the honeycomb panel.

20. The propulsions system of claim 16. wherein the honeycomb panel is made of aluminum.
